(19) United States
(12) Patent Application Publication
(10) Pub. No.: US 2016/0055565 A1
(43) Pub. Date: Feb. 25, 2016

(54) SYSTEMS FOR MODULAR MOBILE ELECTRONIC DEVICE PURCHASING

(71) Applicant: Google, Inc., Mountain View, CA (US)

(72) Inventors: David Fishman, Mountain View, CA (US); Jason Chua, Mountain View, CA (US); Eric Gunther, Mountain View, CA (US); Paul Eremenko, Mountain View, CA (US)

(21) Appl. No.: 14/834,269

(22) Filed: Aug. 24, 2015

Related U.S. Application Data
(60) Provisional application No. 62/040,888, filed on Aug. 22, 2014.

(51) Int. Cl. G06Q 30/06; G06Q 50/00

(52) U.S. Cl. CPC G06Q 30/0627; G06Q 30/0631; G06Q 50/01

(57) ABSTRACT

A system for modular mobile electronic device (MMED) purchasing includes a component selection interface and a recommendation engine, the component selection interface including a search interface that allows MMED components to be searched for using text and filter options, a detail interface that provides detailed descriptions of selected MMED components, a marketplace interface that displays MMED components according to an MMED organizational scheme and links to the search interface and the detail interface.

### CROSS-REFERENCE TO RELATED APPLICATIONS

This application claims the benefit of U.S. Provisional Application No. 62/040,888, filed on 22 Aug. 2014, all of which is incorporated in its entirety by this reference.

### TECHNICAL FIELD

This invention relates generally to the mobile electronics field, and more specifically to new and useful systems for modular mobile electronic device purchasing in the mobile electronics field.

### BACKGROUND

Current methods of mobile electronic device design create devices that are static, both in terms of functionality and in terms of design. Companies try to solve this problem by producing a wide range of devices having different functionalities and different designs. As a result, users of such devices are forced to make compromises; they lack the ability to customize the functionality and design of their mobile devices to truly meet their needs and preferences. Modular mobile electronic devices may serve to meet user needs and preferences by allowing for a wide range of user customization options. The wide range of user customization options available empowers users to configure truly personalized modular mobile electronic devices, but it may also be overwhelming, especially to users less familiar with modular mobile electronic devices. Thus, there is a need in mobile electronics field to create systems for modular mobile electronic device purchasing. This invention provides such new and useful systems.

### BRIEF DESCRIPTION OF THE FIGURES

FIG. 1 is a model view of a modular mobile electronic device;

FIGS. 2A and 2B are image views of modular mobile electronic devices;

FIG. 3 is a diagram view of a system of an invention embodiment;

FIG. 4 is a diagram view of a component selection interface of a system of an invention embodiment;

FIG. 5 is an example view of a marketplace interface of a component selection interface of a system of an invention embodiment;

FIG. 6 is an example view of a search interface of a component selection interface of a system of an invention embodiment;

FIG. 7 is an example view of a detail interface of a component selection interface of a system of an invention embodiment;

FIG. 8 is a model view of an example implementation of emulator modules with a component selection interface of a system of an invention embodiment; .

FIG. 9 is a diagram view of a MMED configuration interface of a system of an invention embodiment;

FIG. 10 is an image view of a linked shell design layout; and

FIG. 11 is an example view of an image and a set of shell designs generated from the image by a shell design interface of a system of an invention embodiment.

### DESCRIPTION OF THE INVENTION EMBODIMENTS

The following description of the embodiments of the invention is not intended to limit the invention to these embodiments, but rather to enable any person skilled in the art to make and use this invention.

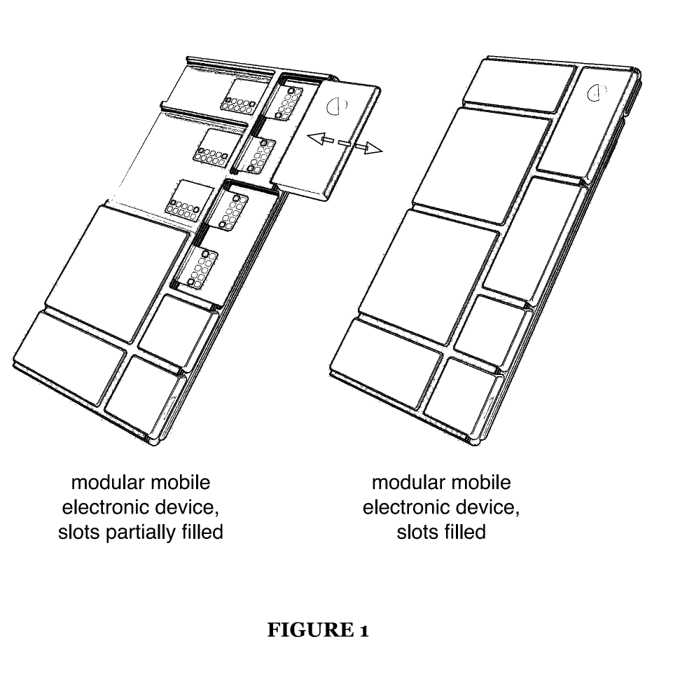

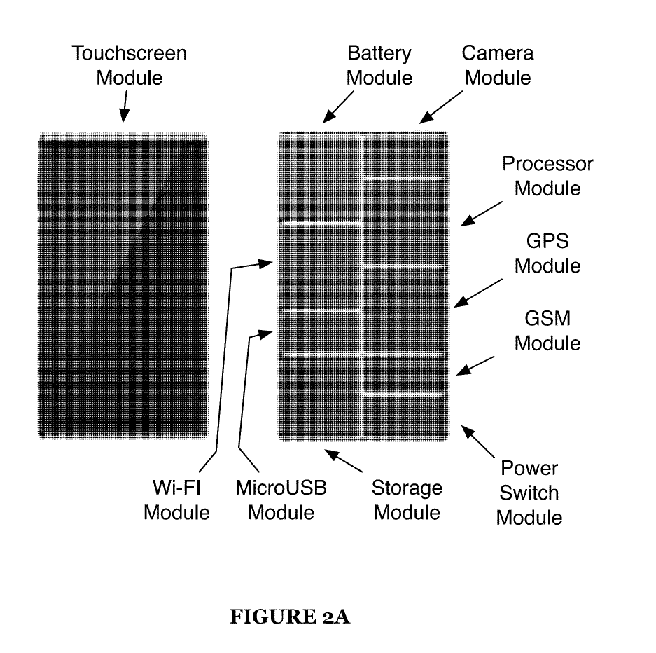

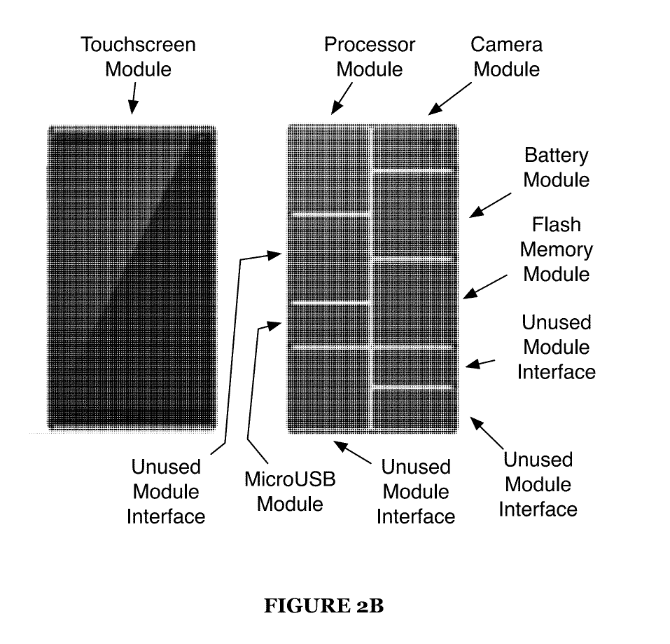

As shown in FIG. 1, modular mobile electronic devices are preferably created and/or modified through the use of user-removable modules. When multiple modules are connected, the modules are preferably enabled, in confederation, to serve as a mobile electronic device. The mobile electronic device created by such a confederation is preferably characterized by the confederated modules as well as the parameters of confederation, which are preferably determined by the confederated modules and any system enabling the confederation of the modules. As shown in FIG. 2A, a modular mobile electronic device configured to serve as a smartphone is an example of a possible mobile electronic device. Other examples of possible mobile electronic devices include those configured to serve as tablets, laptops, media players, cameras, measurement devices, gaming systems, vehicular computing devices, set-top boxes, and televisions.

Modules are preferably user-removable and replaceable, enabling users to create mobile electronic devices with highly varied form and functionality. For example, as shown in FIG. 2B, a user may connect a camera module, a flash memory module, a processor module, a battery module, and a touchscreen LCD module to a modular mobile electronic device to create a small and lightweight camera. The user could later add a cell-phone radio module and a microphone/speaker module to create a camera phone. Modules preferably follow an open and free standard, enabling almost anyone to be a module developer.

The flexibility afforded by module confederation preferably allows for a number of favorable outcomes. Users can purchase only the modules necessary for their needs, allowing for reductions in cost. Users can also choose to replace modules or add additional modules at a later time. In combination, these two outcomes may help increase accessibility to mobile electronic devices (and in many cases, the internet) throughout the world, especially for people for whom a smartphone or a PC is not currently a good value proposition. For example, a user may buy a system and a basic set of modules at a low price point, and transition to a more advanced phone by adding modules later on. These two outcomes may also help slow the creation of electronic waste by allowing mobile electronic devices to be upgraded or modified rather than replaced. Further, because modular mobile electronic devices are compatible with modules of highly varied form and function, and because modules are preferably based on an open standard, module confederation may allow small or specialized companies to make modules playing to their strengths without designing a full mobile electronic device.

Some example module types include sensor modules, processor modules, storage modules, communication modules, display modules, and power modules. Examples of sensor modules include accelerometer modules, GPS modules, camera modules, depth imaging modules, fingerprint reader modules, biometric modules, microphone modules, digital/analog input modules, haptic input modules, infrared flash modules, pedometer modules, barometer modules, magnetometer modules, and gyroscope modules. Examples of processor modules include application processor modules and graphics processor modules. Examples of storage modules include flash memory modules and RAM modules. Examples of communication modules include Wi-Fi radio modules, GSM/CDMA radio modules, HDMI connector modules, NFC modules, Bluetooth radio modules, and USB connector modules. Examples of display modules include touchscreen LCD modules, non-touch graphical display modules, and e-ink display modules. Examples of power modules include battery modules, solar panel modules, and battery charging modules. The variety of modules preferably serve to provide various options and combinations of inputs, outputs, data storage, data processing, communication, power, and other suitable aspects of a computing device. Note that these example module types are in no way exhaustive or exclusive; i.e., modules may incorporate functionality from many of these example types or from none at all, and modules may additionally or alternatively incorporate suitable functionality not herein described.

Modules may feature user-replaceable module covers. Enabled by 3D printing or other processes, the appearance of the module shell (and thus, the outward appearance of the module) may be selected or even designed by module buyers. In addition to changing the appearance of the module, module covers may additionally add functionality to the module. For example, a module cover might include an integrated charging mechanism, an antenna, integrated electronics, lenses (e.g., for a camera module), etc.

The number of potential module designs leads to an enormous number of possible modular mobile electronic device configurations. An example modular mobile electronic device chassis (here part of an endoskeleton) holds eight modules; two small, four medium, and two large, as shown in FIG. 1. If there are only five distinct types of module for each size, the modular mobile electronic device may be uniquely configured in over 48,000 ways. If there are twenty-five distinct types of module for each size, that number rises to over 100 billion. The level of customizability enabled by modular mobile electronic devices can be extremely powerful, but choosing a configuration can be just as overwhelming.

Given the large number of options available, it may be important that customers are able to select, configure, and/or purchase modular mobile electronic devices and modular mobile electronic device components (e.g. modules, chassis, accessories) in a manner that allows processes of selection, configuration, and/or purchase to be guided. Guiding customers allows customers to narrow down component choices, to better identify beneficial or complementary component choices, and to increase the likelihood that the component choices address customer needs.

The following systems may address these issues by allowing customers to select, configure, and/or purchase modular mobile electronic devices and modular mobile electronic device components through guided interfaces and/or processes.

The modules and/or modular mobile electronic devices of the following systems are preferably those described in U.S. Provisional Application No. 61/976,173 and/or U.S. Provisional Application No. 61/976,195, which are incorporated in their entirety by this reference. The modules and modular mobile electronic devices may additionally or alternatively be any suitable modules and modular mobile electronic devices.

### System for Modular Mobile Electronic Device Purchasing

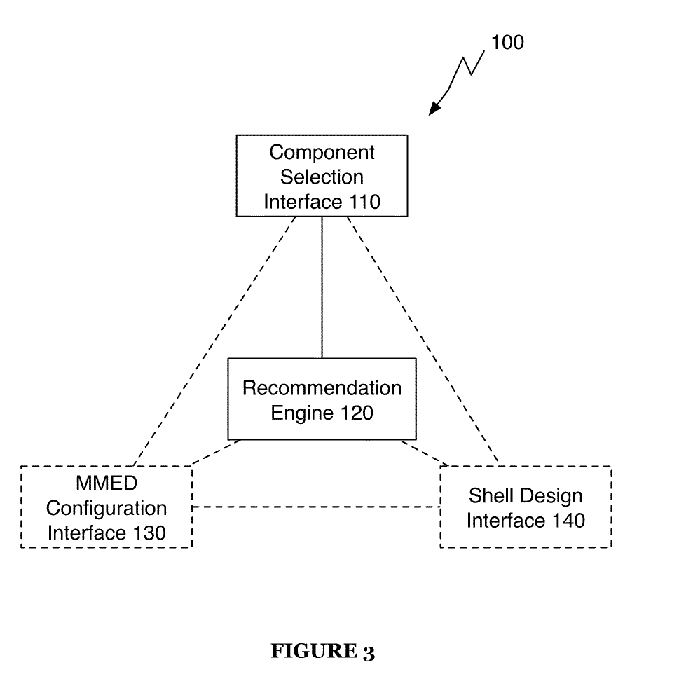

As shown in FIG. 3, a system 100 for modular mobile electronic device (hereafter referred to as MMED) purchasing includes a component selection interface 110 and a recommendation engine 120. The system 100 may additionally include a MMED configuration interface 130 and/or a shell design interface 140.

The system 100 functions to provide a purchasing experience for MMED customers that assists customers in selecting MMED products (e.g., modules, chassis/endoskeletons, accessories, complete MMEDs). The system 100 operates on an electronic device with a display; some examples including tablets, laptop computers, desktop computers, media players, cameras, measurement devices, gaming systems, vehicular computing devices, and televisions. Particularly, the system 100 preferably operates on a MMED; if the system 100 operates on a MMED, the system 100 preferably takes advantage of this by running routines that require operating a MMED as a prerequisite (e.g. detecting the configuration of the MMED, detecting when modules are attached and/or removed, collecting data from the MMED). Additionally, the system 100 might take advantage of this by using interfaces or gestures that mimic the MMED experience (for example, removing modules in a management interface might resemble physically removing modules from the MMED).

Customers preferably interact with the system 100 through the component selection interface 110 (and the MMED configuration interface 130 and/or shell design interface 140 if included with the system 100) but may additionally or alternatively interact with the system through any suitable method of input. The interfaces of the system 100 are preferably touch-interactive graphical user interfaces (GUIs) operating on a touch screen, but may additionally or alternatively be any suitable user interface (e.g. non-touch interactive GUI used with a laptop).

The system 100 preferably has multiple states of operation; these states of operation function to store system 100 configuration details (e.g. startup screen, personalization, etc.). In one implementation, the system 100 operates on a MMED and includes a normal mode of operation and a “guest mode” of operation. The system 100 defaults to the normal mode of operation; in the normal mode, the system 100 is linked to the configuration of the MMED it is operating on, and may additionally link to account details of the MMED user. In this normal mode of operation, the system 100 preferably defaults to interfaces that enable the MMED user to buy more components for an existing device (e.g., presenting the user with an MMED management screen upon system 100 launch). The user has the option of switching the system 100 into “guest mode”; this defaults to an interface intended for customers without MMEDs; for instance, a friend looking to purchase an MMED. In this way, the friend can purchase his MMED through another MMED.

The system 100 preferably stores data in the cloud, linked to a particular user account, but may additionally or alternatively store data in any location (e.g. locally) and linked to a particular user or device by any method (e.g. by MMED serial number, by IP address, etc.).

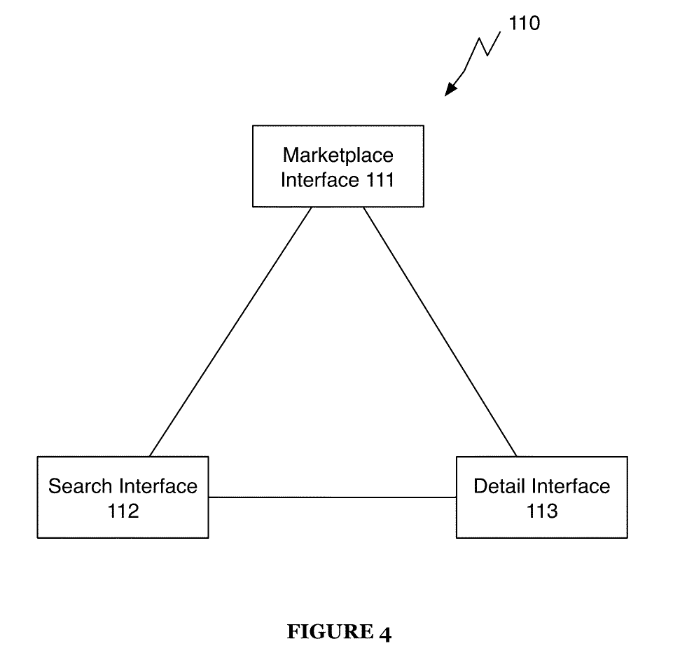

As shown in FIG. 4, the component selection interface 110 functions to provide customers with a mechanism for selecting MMED components. MMED components may include modules, module shells, MMED chassis, MMED endoskeletons (e.g. chassis with integrated MMED enabling systems), MMED accessories/add-ons, MMED applications, or any other components or systems related to MMEDs. The component selection interface 110 preferably includes a marketplace interface 111, a search interface 112, and/or a detail interface 113; but may additionally or alternatively include any suitable set of interfaces.

The component selection interface no preferably enables components selected to be purchased, saved for later use, and/or sent to an MMED configuration interface 130, but may additionally or alternatively enable any suitable action for selected components.

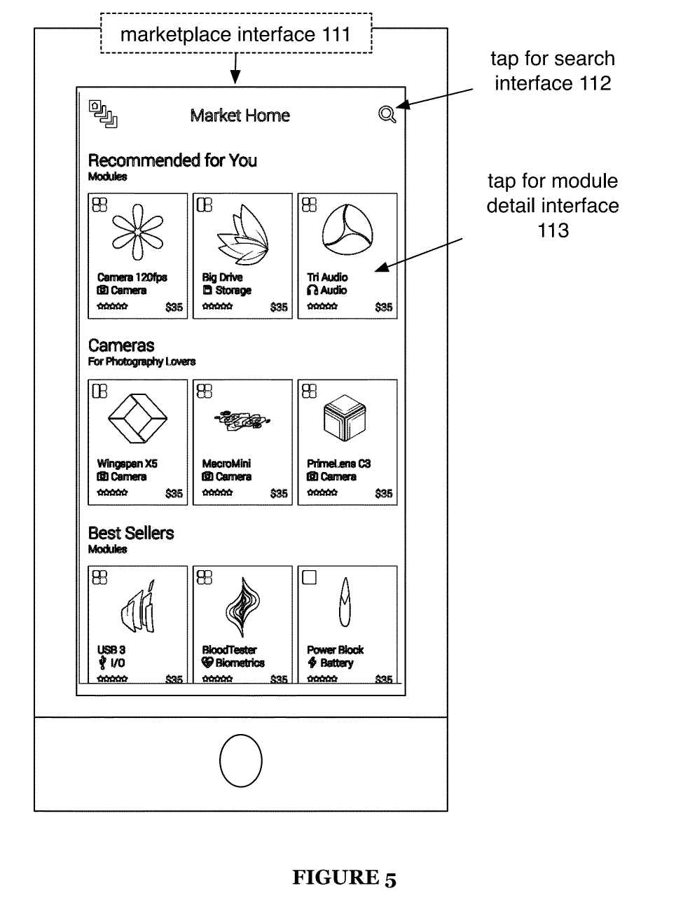

As shown in FIG. 5, the marketplace interface in preferably serves as the launch interface for the component selection interface no. The marketplace interface in functions to provide a list, array, or other arrangement of MMED components for customers to select. The marketplace interface in preferably represents MMED components with a combination of icons and text, but may additionally or alternatively represent MMED components in any suitable way. The marketplace interface 111 may organize MMED components in a number of ways; for example, by component type, by component use (e.g. a “Power” category might include charger modules, battery modules, and charging accessories), by component price, and/or by component age. Components might also be organized using generally applicable component groups like “Staff Picks”, “Components of the Week”, “Most Popular Components”, etc. or personalized component groups, like “Components Recommended for You”, “Components Compatible with Your Device”, etc. These organizational strategies might be combined in a variety of ways; for instance, “Power Modules Compatible with Your Device” or “Staff Picks under $10”.

The MMED components as displayed in the marketplace interface 111 are preferably organized according to a marketplace organizational scheme, which uses some combination of the MMED component organizations above, but may additionally or alternatively be organized in any suitable manner. The marketplace organizational scheme is preferably personalized, enabling different organizational schemes for different customers or groups of customers. The marketplace organizational scheme may be personalized based on a variety of inputs; e.g., customer browsing history, customer purchase history, customer location, customer demographic information, time of marketplace access, device used for marketplace access, and/or any other relevant information. The marketplace organizational scheme may additionally or alternatively be personalized based on user input; e.g. a user pinning a “Components Recommended for You” component group to the top of the marketplace interface 111, or a user selecting the text of the “Power” group to refocus the marketplace interface 111 on just that group.

The marketplace interface in preferably includes links to search interfaces 112 and detail interfaces 113; search interfaces 112 and detail interfaces 113 may additionally or alternatively be accessed in any suitable manner. In one implementation, the marketplace interface in includes a search icon that launches a search interface 112, and each component represented in the marketplace interface in includes an icon that launches a detail interface 113 for that component.

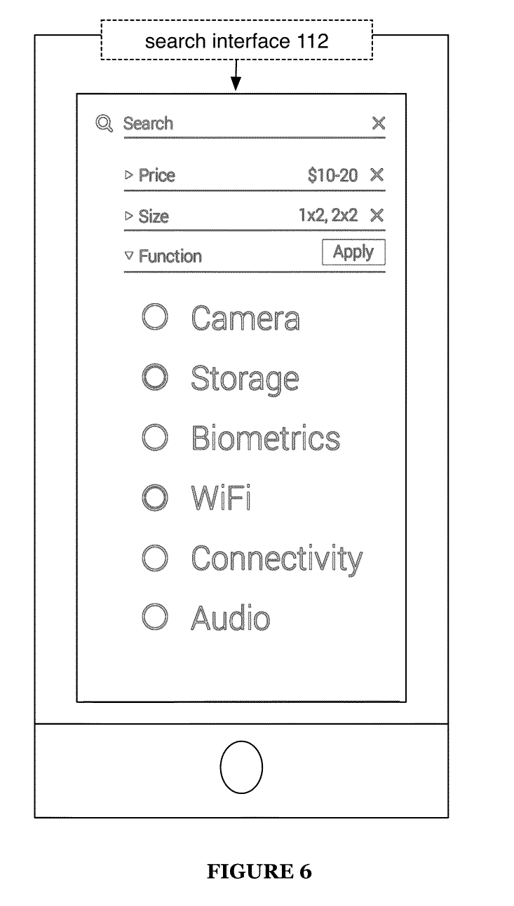

As shown in FIG. 6, the search interface 112 functions to allow customers to search MMED components available for purchase. The search interface 112 preferably includes a text search interface, allowing customers to search by keyword (e.g. “camera”), and a filter interface, allowing customers to filter search results based on component categories, but may additionally or alternatively include any suitable set of interfaces. The filter interface may additionally or alternatively enable filtering of components in the marketplace interface 111 (e.g. choosing a filtering option with no keyword simply applies the filter to the components displayed in the marketplace interface in). Examples of component categories include type (e.g., module, accessory, endoskeleton, shell), price (e.g. $10-$20, >$50, etc.), module size/configuration (e.g. 1×2, 2×2, etc.), function (data storage, energy production, etc.), and module type (e.g., camera, processor, microphone). The search interface 112 may additionally or alternatively allow searching with other filter options, including filtering components to display only components compatible with a particular MMED or a particular component.

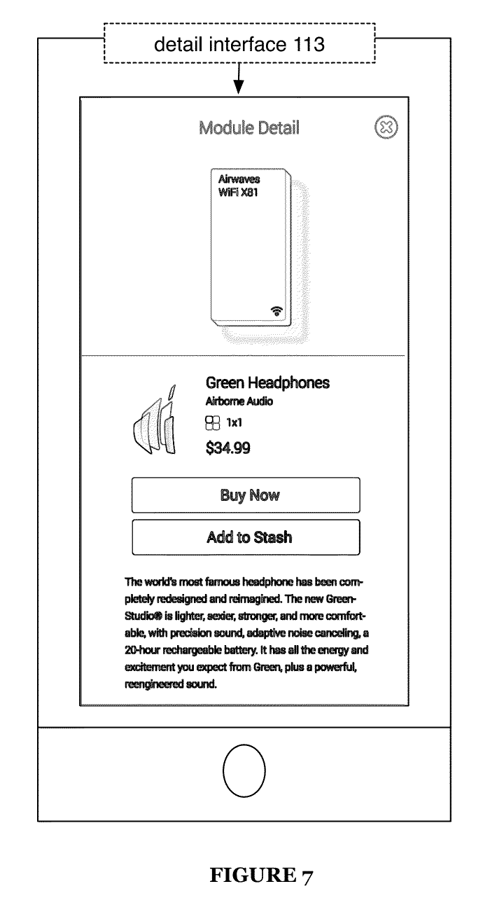

As shown in FIG. 7, the detail interface 113 functions to provide detailed descriptions of selected components or component groups to customers. The detail interface 113 is preferably accessed by selecting a component in the marketplace interface 111 or the search interface 112, but may additionally or alternatively be accessed in any suitable manner. The detail interface 113 includes information about the selected component; for example, a picture of the component, the component manufacturer, the component price, the component size, a component description, and/or component metadata. The detail interface 113 may include interfaces that allow for the purchase of the component, for the component to be saved, for the component to be sent to a MMED configuration interface 130, and/or any other suitable set of interfaces.

The detail interface 113 may additionally or alternatively include customization interfaces for components. For example, the detail interface 113 may include a drop-down box for an antenna module that allows customers to select between antenna types (e.g. CDMA and GSM). As another example, the detail interface 113 for a processor module may include an interface that allows the selection of a shell designed with the shell design interface 140 (or any other selectable module shells).

Similarly to the marketplace interface in, the detail interface 113 may be personalized based on a variety of inputs; e.g., customer browsing history, customer purchase history, customer location, customer demographic information, time of marketplace access, device used for marketplace access, user input, and/or any other relevant information. For example, a user searching for components for a gaming experience may care more about details related to gaming (e.g., displaying performance characteristics over descriptions of how easy the module is to use).

The detail interface 113 may additionally or alternatively include compatibility and/or comparative displays. Compatibility displays function to display compatibility with another component; for example, a module incompatible with an MMED configuration known to the system 100 may include a warning label conveying this information. Comparative displays function to compare components to other components; for example, the detail interface 113 for a module might include comparisons to similar modules already owned by customers. As a more specific example, a processor module detail interface 113 might include a section that indicates that the processor module is 30% faster and draws 10% more power than the processor module currently in use by the customer.

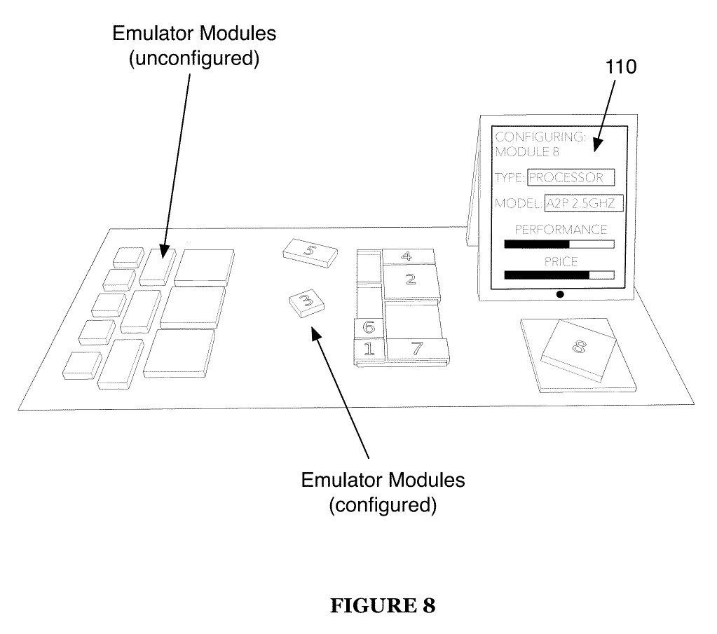

In one variation of the invention, the component selection interface 110 includes an interface directing an emulator module to emulate a selected component. Emulator modules function to allow customers to tangibly configure modular mobile electronic devices while emulating the experience of assembling a modular mobile electronic device from its constituent modules. Customers place emulator modules into an emulator module chassis, creating a device that looks and feels like the MMED that customers may eventually buy. The emulator modules are preferably configurable to represent any of a subset of available modules (e.g., a small sized emulator module may be able to represent any other small sized emulator module). The emulator modules are preferably configured using a module configurator of the component selection interface 110, but may additionally or alternatively be configured by the emulator modules themselves or by any other suitable system. An example implementation of the emulator modules with the component selection interface no is as shown in FIG. 8. Emulator modules preferably function as described in U.S. Provisional Application No. 62/040,882, which is incorporated in its entirety by this reference, but may additionally or alternatively function in any suitable manner.

The recommendation engine 120 functions to create component recommendations to customers based on a variety of customer and/or component data. As customer data may vary from person to person, these component recommendations enable the system 100 to assist each customer in selecting modules that are more likely to be of interest to the customer. In this way, the component recommendations produced by the recommendation engine 120 may be personalized.

The recommendation engine 120 may source data for producing recommendations from a variety of sources. Some examples of input data include customer browsing history, customer demographic data (e.g. age, location, nationality, gender), customer purchase history, customer ratings, user input (e.g. a user selecting a button that says “Show me more components like this one”), time, device information (e.g. for an MMED, module/configuration information), or any other suitable source of customer information. Input data may be stored by the system 100 or may be retrieved from any suitable source (e.g. if the recommendation engine 120 is linked to a webmail account and has access to that account, input data may include information from that webmail account).

Recommendations produced by the recommendation engine 120 may include particular components, component classes, organizational schemes, or any other aspect of the system 100 that may be personalized. For example, the recommendation engine 120 may determine from customer browsing history that a particular customer frequently views camera modules in the component selection interface no. The recommendation engine 120 may modify the marketplace interface 111 to feature components related to photography more prominently, fill a “Components recommended for you section” with photography-related modules, and notify the customer when sales on photography-related components occur.

The recommendation engine 120 preferably produces recommendations for the component selection interface no. These recommendations may be used by the component selection interface 110 in a variety of ways. For example, the recommendation engine 120 may modify or set the marketplace organizational scheme of the marketplace interface in, including filling personalized component groups with components. As another example, the recommendation engine 120 may include a component recommendation on the detail interface 113 of a different component. As a third example, the recommendation engine 120 may modify search options of the search interface 112 by hiding search options rarely used by a customer.

The recommendation engine 120 may additionally or alternatively produce recommendations for the MMED configuration interface 130 or the shell design interface 140. For example, the recommendation engine 120 may suggest design apps or shell design apps; it may also guide the input of the MMED configuration interface 130 or shell design interface 140.

The recommendation interface 120 preferably links recommendations to a an online account used to make purchases, but may additionally or alternatively link recommendations to a particular device or to any other suitable indicator of identity (e.g. IP Address).

The MMED configuration interface 130 functions to enable the configuration and/or design of MMEDs from MMED components. MMED configurations preferably include a set of components that may be combined into a MMED, often in multiple ways. MMED configurations may additionally include one or more saved combinations. For example, an MMED configuration may include an endoskeleton with eight module slots, a camera module, two battery modules, a processor module, two storage modules, a display module, a cell antenna module, a Wi-Fi module, and a microphone/speaker module. This MMED configuration may include two saved combinations, a “Phone combination” (endoskeleton, camera module, one battery module, storage module, processor module, display module, cell antenna module, Wi-Fi module, and microphone/speaker module) and a “Camera combination” (endoskeleton, camera module, two battery modules, two storage modules, processor module, display module, and Wi-Fi module).

The MMED configuration interface 130 preferably acts as the system-level companion to the component selection interface 110; the MMED configuration interface 130 may allow customers to explore adding or modifying components of an existing MMED, to explore designing an entirely new MMED, and/or to explore other data relating to the interaction of MMED components.

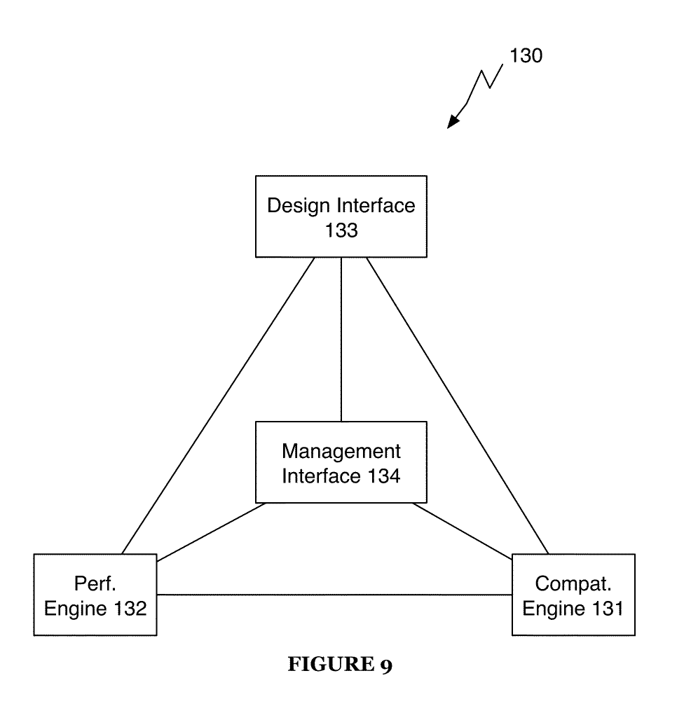

In one implementation, the MMED configuration interface 130 includes a compatibility engine 131, a performance engine 132, a design interface 133, and a management interface 134, as shown in FIG. 9.

The compatibility engine 131 functions to determine compatibility between components of an MMED. The compatibility engine 131 preferably determines compatibility between MMED components based on manufacturer data on the components, but may additionally or alternatively determine compatibility based on any suitable data; e.g., user data. The compatibility engine 131 may determine compatibility based on a number of measures of compatibility; for example, power requirements, component size, and/or operating system compatibility. Some additional sources for compatibility data may include component compatibility data (e.g. a particular module's manufacturer data may explicitly indicate that it is incompatible with a set of other modules), device reports (e.g. reports indicating a particular component combination results in device errors or failures), and/or performance measures (e.g. benchmarks indicating that wireless performance decreases significantly when two components are used in the same MMED).

The compatibility engine 131 might indicate compatibility using a number of compatibility metrics; in one implementation, compatibility is indicated by a compatibility score from 1-10 where 1 is least compatible and 10 is most compatible. In another implementation, the compatibility engine 131 simply indicates whether a component is compatible or not with a set of other components.

The compatibility engine 131 is preferably used by the design interface 133 and the management interface 134 but may additionally or alternatively be used in any manner by the system 100. For example, the compatibility engine 131 might be used on a detail interface 113 to show whether a particular component is compatible with a customer's MMED.

The performance engine 132 functions to generate performance metrics of a particular MMED configuration and/or MMED component. The performance engine 132 preferably generates performance metrics based on manufacturer data of MMED components, but may additionally or alternatively base performance metric generation on any suitable data; e.g., data collected from MMED component users. The performance engine 132 may generate performance metrics for a variety of performance types and may base performance metrics on a variety of component data. Performance metrics are preferably generated for either an individual component or an MMED configuration, but may additionally or alternatively be generated for any set of components. Performance metrics for individual components might include power consumption metrics for power-consuming modules, power storage metrics for battery modules, and/or processing metrics for processor modules. Performance metrics for MMED configurations might include overall processing power metrics, and/or battery lifetime metrics. Performance metrics may be general performance metrics (as in some of the previous examples) or function-specific performance metrics. For example, examples of function-specific MMED performance metrics including a gaming performance metric or a photography performance metric (i.e. how suitable an MMED configuration is for photography).

Performance metrics are preferably represented as objective scores (e.g., 1-10) but may additionally or alternatively be comparative (e.g. Module A outperforms Module B for a given metric) or be represented in any other suitable form.

The performance engine 132 is preferably used by the design interface 133 and the management interface 134 but may additionally or alternatively be used in any manner by the system 100. For example, the compatibility engine 131 might be used on a detail interface 113 to give performance metrics about a particular MMED component.

The design interface 133 functions to allow customers to design MMED configurations. The design interface 133 preferably provides customers a choice of multiple methods for designing an MMED configuration (e.g., a set of MMED components that, if purchased, could be assembled into a MMED), but may additionally or alternatively provide customers with a single design method.

The design interface 133 preferably includes a manual design method that allows customers to design an MMED configuration by selecting MMED components from the component selection interface 110. The manual design method preferably prompts customers to select MMED components, but may additionally or alternatively allow customers to load a saved set of MMED components (e.g. saved as part of a wish list in the component selection interface 110).

The design interface 133 may additionally or alternatively include other design methods, including guided design methods. In one implementation, the design interface 133 links to external applications (hereafter referred to as “design apps”) and allows for customers to design MMED configurations in these design apps and use the configurations with the system 100. For example, the design interface 133 might link to a design app made by a fitness company that helps design MMED configurations ideal for use with their products (or for fitness in general).

Guided design methods function to help customers design MMED configurations based on customer input and/or other data. Guided design methods may range in assistance levels from providing a few simple prompts or a template (e.g., prompting a customer to pick an endoskeleton, a processor, a display, and a battery) to designing an MMED configuration without any direct customer component choices (e.g. designing an MMED configuration based on customer answers to lifestyle questions).

For example, one guided design method might help a customer design MMED configurations based in part on the customer's social network history (for example, which pages they have “liked”, demographic data of their social network connections, etc.). As another example, a guided design method might ask a customer questions about how they would like to use their MMED, such as “Will this device be primarily used as a phone, as a camera, or for another purpose?” or “How important is battery life to you?” with a slider underneath the question to indicate battery life importance. The design interface 133 may additionally or alternatively receive information from the recommendation engine 120 as input; for example, the recommendation engine 120 may recommend that the design interface 133 ask more questions surrounding photography for a customer that takes many pictures.

The design interface 133 may also include guided design methods that allow customers to design MMED configurations based on the configurations of other customers. For example, if MMED configurations are linked to a particular social media platform, a customer may be able to access the MMED configurations of his/her friends and use them as templates for their own MMED configuration. As another example, if the system 100 is operating in “Guest Mode” on an MMED, the guest customer may be able to create an MMED configuration based on the configuration of the MMED currently running the system 100 (the “Host” MMED).

The design interface 133 preferably creates MMED configurations based in part on component compatibility. The design interface 133 preferably uses the compatibility engine 131 during design to determine component compatibility, but may additionally or alternatively determine component compatibility in any other suitable manner (e.g. using only a set of components pre-determined to be compatible with each other). The design interface 133 may additionally or alternatively use the performance engine 132 in MMED design; for instance, a guided design method that asks customers “How important is gaming performance to you?” may assign a particular weighting to gaming performance, as determined by the performance engine 132, in creating an MMED configuration.

The design interface 133 preferably allows customers to save MMED configurations to be used with the management interface 134. The design interface 133 may additionally or alternatively allow customers to purchase the MMED components of a particular configuration directly from the design interface 133 and/or share MMED configurations with friends (e.g. via email, over a social network, etc.).

The management interface 134 functions to allow the management of saved MMED configurations. The management interface 134 preferably enables customers to add, view, delete, and/or modify saved MMED configurations. The management interface 134 preferably includes an interface for switching between saved MMED configurations; this may be implemented in a launch screen, in a drop-down menu on a detail interface for an MMED configuration, or in any suitable manner.

When an MMED configuration is selected for viewing in the management interface 134, customers are preferably able to view the components in the MMED configuration and any saved component combinations. The management interface 134 may additionally or alternatively display information about the MMED configuration as a whole, including compatibility information (preferably sourced by the compatibility engine 131) and performance information (preferably sourced by the performance engine 132).

The management interface 134 preferably enables customers to modify MMED configurations directly from a configuration view screen, but may additionally or alternatively enable modification of MMED configurations in any suitable manner. The management interface 134 preferably allows customers to remove components or add components from an MMED configuration, and to create/modify/remove MMED combinations (as previously described). The management interface 134 preferably allows customers to add components through the component selection interface 110. Additionally or alternatively, the management interface 134 may access components from a saved component group (e.g. one previously saved during a session with the component selection interface, or one received from a friend).

The management interface 134 may additionally or alternatively enable the selection of module shells for modules of an MMED configuration; module shells may be selected through the component selection interface 110 as with any other component, but may additionally or alternatively be applied from a module shell configuration saved by the shell design interface 140 or any other suitable source.

If the management interface 134 is part of a system 100 running on an MMED, the management interface 134 preferably includes the ability to store the current MMED configuration (hereafter referred to as a ‘substantive configuration’) as a saved configuration. The management interface 134 may additionally or alternatively enable the detection of attached modules; for example, if a new module is attached to an MMED, the management interface 134 may prompt a user: “Would you like to add this module to ‘My Modules’?” Components may additionally or alternatively be added manually through user entry or in any other suitable manner. Any ‘substantive configuration’ and components associated with it are preferably made visually distinct from components and/or MMED configurations that the customer does not currently claim ownership of. For example, a module detail interface 113 for an owned module might say “Buy Another” instead of “Buy Now”. Likewise, viewing a substantive configuration in the management interface 134 might provide different options, like “transfer component” or “sell component”, than for a non-substantive configuration.

If the management interface 134 is run on a system including emulator modules, this may also be recognized by the management interface 134, for example, the management interface 134 might include a view similar to that for substantive configurations, but instead of options like “transfer component” might include options like “assign component to emulator module 1”.

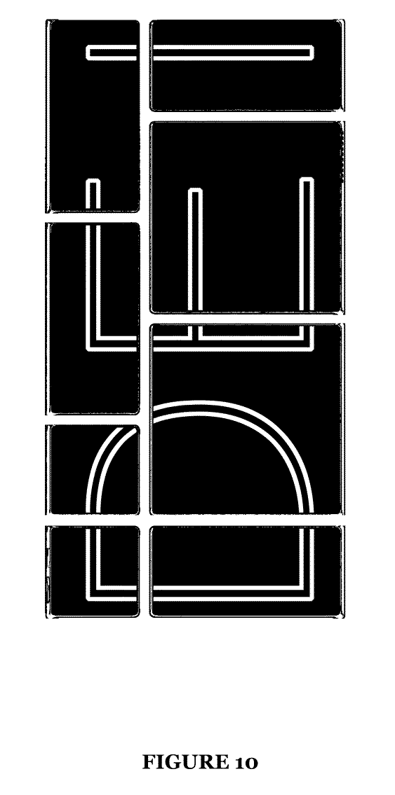

The shell design interface 140 functions to allow customers to create and/or select module shell designs. The shell design interface 140 preferably enables customers to save shell designs to be used with the design interface 133 and/or the management interface 134. After module shell designs are selected, they may be sent to a module shell manufacturer, which may convert the designs to module shells. Module shells are preferably ₃D printed, allowing for a wide range of customer designs. Module shell designs may include individual designs for a shell and/or sets of linked shell designs, which may be arranged in a particular layout, as shown in FIG. 10.

The shell design interface 140 preferably provides customers a choice of multiple methods for choosing and/or creating module shell designs, but may additionally or alternatively provide customers with a single design method.

The shell design interface 140 preferably includes a manual design method that allows customers to create shell designs by selecting a shell size and applying an uploaded image or choosing from selection of existing images, colors, and/or patterns.

The shell design interface 140 may additionally or alternatively include other design methods, including guided design methods. In one implementation, the shell design interface 140 links to external applications (hereafter referred to as “shell design apps”) and allows for customers to create and/or select shell designs in these shell design apps and use the shell designs with the system 100. For example, the shell design interface 140 might link to a shell design app made by a fashion accessories company that helps create personalized shell designs ideal for use with their products (or correspond to a particular style).

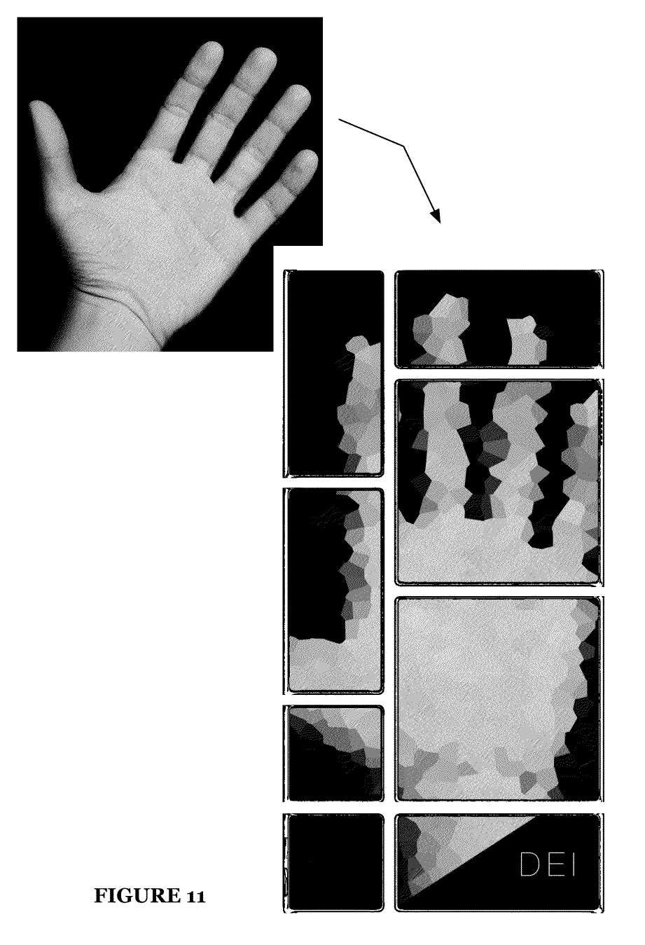

Guided design methods function to help customers design shell designs based on customer input and/or other data. Guided design methods may range in assistance levels; some examples include providing a few simple prompts or a template (e.g., prompting a customer to pick from sets of coordinated shell designs), creating a set of coordinated shell designs from a customer-provided image (as shown in FIG. 11), and creating a shell design without any direct customer shell design choices (e.g. creating a shell design based on customer answers to lifestyle questions).

The shell design interface 140 may additionally or alternatively receive information from the recommendation engine 120 as input; for example, the recommendation engine 120 may recommend that the design interface 133 focus more on abstract patterns for a customer that purchases a lot of abstract art.

For example, one guided design method might help a customer create and/or select shell designs based in part on the customer's social network history (for example, which pages they have “liked”, demographic data of their social network connections, etc.). As another example, a guided design method might ask a customer questions about how their style, such as “Do you typically wear dark colors or light colors?” or “How casual is your style?” with a slider underneath the question to indicate how casual the customer's style is.

The shell design interface 140 may also include guided design methods that allow customers to create/select shell designs based on the designs of other customers. For example, if shell designs are linked to a particular social media platform, a customer may be able to access the shell designs of his/her friends and use them as templates for their own shell designs. As another example, if the system 100 is operating in “Guest Mode” on an MMED, the guest customer may be able to create shell designs based on the shell designs of the MMED currently running the system 100 (the “Host” MMED).

As a person skilled in the art will recognize from the previous detailed description and from the figures and claims, modifications and changes can be made to the embodiments of the invention without departing from the scope of this invention defined in the following claims.

What is claimed is:

1. A system for modular mobile electronic device (MMED) purchasing comprising:
a component selection interface that enables users to view and select MMED components, the component selection interface comprising:
a search interface that allows MMED components to be searched for using text and filter options;
a detail interface that provides detailed descriptions of selected MMED components;
a marketplace interface that displays MMED components according to an MMED organizational scheme and links to the search interface and the detail interface; and
a recommendation engine that creates MMED component recommendations based on at least one of customer data and component data;
wherein the system operates on an electronic device having a display.

2. The system of claim 1, wherein the electronic device is an MMED and the system collects configuration data from the MMED.

3. The system of claim 2, wherein the MMED organizational scheme is personalized based on at least one of customer browsing history, customer purchase history, and customer demographic information.

4. The system of claim 1, wherein the detail interface includes a compatibility display that displays whether a selected MMED component is compatible with a first set of other MMED components.

5. The system of claim 4, wherein the detail interface includes a comparative display that displays performance comparisons between the selected MMED component and a second set of other MMED components; wherein the first and second sets of MMED components are not identical.

6. The system of claim 1, wherein the detail interface is enabled to direct an emulator module to emulate a selected MMED component.

7. The system of claim 1, wherein data output by the recommendation engine is used to adapt the MMED organizational scheme.

8. The system of claim 1, further comprising an MMED configuration interface that enables the configuration and design of MMEDs based on a set of selected MMED components; wherein the MMED configuration interface comprises:
a compatibility engine that determines compatibilities of MMED components based on at least one of user data and manufacturer data; wherein the compatibility engine outputs a compatibility metric;
a performance engine that generates performance metrics of a set of MMED components based on at least one of user data and manufacturer data; and
a design interface that allows users to design and save MMED configurations; and
a management interface that allows users to manage saved MMED configurations.

9. The system of claim 8, wherein the design interface allows users to design MMED configurations using a manual design method.

10. The system of claim 8, wherein the design interface allows users to design MMED configurations using a guided design method.

10. system of claim 10, wherein the electronic device is an MMED; wherein the management interface allows users to view an MMED configuration based on a current configuration of the MMED.

12. The system of Claim ii, wherein the management interface is capable of detecting modules coupled to the MMED.

13. The system of claim 12, wherein the management interface is capable of retrieving a list of stored modules associated with the MMED; wherein the list of stored modules associated with the MMED is retrieved from a user account history or a history of modules coupled to the MMED.

14. The system of claim 1, further comprising a shell design interface that enables the design or selection of module shell designs.

15. The system of claim 14, wherein the shell design interface allows users to create module shell designs using a guided design method.

16. The system of claim 8, wherein the system is operable in a normal mode and a guest mode; wherein the system defaults to the management interface when in normal mode and the system defaults to the design interface when in guest mode.

17. The system of claim 16, wherein the design interface may use an MMED configuration associated with the normal mode as a template when the system is in guest mode.

18. The system of claim 1, wherein the recommendation engine creates MMED component recommendations based on a user's social network history.

19. The system of claim 1, wherein the recommendation engine creates MMED component recommendations based on a user's responses to questions about a user's intended use of the MMED.

20. The system of claim 19, wherein the questions include questions requiring a user to prioritize MMED performance relative to MMED battery life.
